(19) United States
(12) Patent Application Publication
(10) Pub. No.: US 2004/0146650 A1
(43) Pub. Date: Jul. 29, 2004

(54) EFAB methods and apparatus including spray metal or powder coating processes

(75) Inventors: Michael S. Lockard, Lake Elizabeth, CA (US); Adam L. Cohen, Los Angeles, CA (US); Roger W. Barton, Andover, MA (US)

Correspondence Address: Microfabrica Inc., 1103 W. Isabel St., Burbank, CA, 91506, US

(73) Assignee: Microfabrica Inc.

(21) Appl. No.: 10/697,597

(22) Filed: Oct. 29, 2003

Related U.S. Application Data
(60) Provisional application No. 60/422,008, filed on Oct. 29, 2002.
(60) Provisional application No. 60/435,324, filed on Dec. 20, 2002.

(51) Int. Cl. B05D 1/36; B05D 3/10

(52) U.S. Cl. 427/307; 427/402; 427/446

(57) ABSTRACT

Various embodiments of the invention present techniques for forming structures via a combined electrochemical fabrication process and a thermal spraying process or powder deposition processes. In a first set of embodiments, selective deposition occurs via masking processes (e.g. a contact masking process or adhered mask process) and thermal spraying or powder deposition is used in blanket deposition processes to fill in voids left by selective deposition processes. In a second set of embodiments, after selective deposition of a first material, a second material is blanket deposited to fill in the voids, the two depositions are planarized to a common level and then a portion of the first or second materials is removed (e.g. by etching) and a third material is sprayed into the voids left by the etching operation. In both embodiments the resulting depositions are planarized to a desired layer thickness in preparation for adding additional layers.

### RELATED APPLICATIONS

This application claims benefit to U.S. Provisional Patent Application No. 60/422,008, filed Oct. 29, 2002 and to U.S. Provisional Patent Application No. 60/435,324, filed Dec. 20, 2002, both of which are incorporated herein by reference as if set fourth in full.

### FIELD OF THE INVENTION

The present invention relates generally to the field of Electrochemical Fabrication and the associated formation of three-dimensional structures (e.g. microscale or mesoscale structures). In particular, it relates to methods and apparatus for forming such three-dimensional structures using a combination of electrochemical deposition techniques and spray deposition techniques or powder deposition techniques (e.g. for metal deposition).

### BACKGROUND OF THE INVENTION

A technique for forming three-dimensional structures (e.g. parts, components, devices, and the like) from a plurality of adhered layers was invented by Adam L. Cohen and is known as Electrochemical Fabrication. It is being commercially pursued by Microfabrica Inc. (formerly MEMGen® Corporation) of Burbank, Calif. under the name EFAB™. This technique was described in U.S. Pat. No. 6,027,630, issued on Feb. 22, 2000. This electrochemical deposition technique allows the selective deposition of a material using a unique masking technique that involves the use of a mask that includes patterned conformable material on a support structure that is independent of the substrate onto which plating will occur. When desiring to perform an electrodeposition using the mask, the conformable portion of the mask is brought into contact with a substrate while in the presence of a plating solution such that the contact of the conformable portion of the mask to the substrate inhibits deposition at selected locations. For convenience, these masks might be generically called conformable contact masks; the masking technique may be generically called a conformable contact mask plating process. More specifically, in the terminology of Microfabrica Inc. (formerly MEMGen® Corporation) of Burbank, Calif. such masks have come to be known as INSTANT MASKS™ and the process known as INSTANT MASKING™ or INSTANT MASKTM plating. Selective depositions using conformable contact mask plating may be used to form single layers of material or may be used to form multi-layer structures. The teachings of the '630 patent are hereby incorporated herein by reference as if set forth in full herein. Since the filing of the patent application that led to the above noted patent, various papers about conformable contact mask plating (i.e. INSTANT MASKING) and electrochemical fabrication have been published:

(1) A. Cohen, G. Zhang, F. Tseng, F. Mansfeld, U. Frodis and P. Will, “EFAB: Batch production of functional, fully-dense metal parts with micro-scale features”, Proc. 9th Solid Freeform Fabrication, The University of Texas at Austin, p161, Aug. 1998.

(2) A. Cohen, G. Zhang, F. Tseng, F. Mansfeld, U. Frodis and P. Will, “EFAB: Rapid, Low-Cost Desktop Micromachining of High Aspect Ratio True 3-D MEMS”, Proc. 12th IEEE Micro Electro Mechanical Systems Workshop, IEEE, p244, January 1999.

(3) A. Cohen, “3-D Micromachining by Electrochemical Fabrication”, Micromachine Devices, March 1999.

(4) G. Zhang, A. Cohen, U. Frodis, F. Tseng, F. Mansfeld, and P. Will, “EFAB: Rapid Desktop Manufacturing of True 3-D Microstructures”, Proc. 2nd International Conference on Integrated MicroNanotechnology for Space Applications, The Aerospace Co., Apr. 1999.

(5) F. Tseng, U. Frodis, G. Zhang, A. Cohen, F. Mansfeld, and P. Will, “EFAB: High Aspect Ratio, Arbitrary 3-D Metal Microstructures using a Low-Cost Automated Batch Process”, 3rd International Workshop on High Aspect Ratio MicroStructure Technology (HARMST'99), June 1999.

(6) A. Cohen, U. Frodis, F. Tseng, G. Zhang, F. Mansfeld, and P. Will, “EFAB: Low-Cost, Automated Electrochemical Batch Fabrication of Arbitrary 3-D Microstructures”, Micromachining and Microfabrication Process Technology, SPIE 1999 Symposium on Micromachining and Microfabrication, September 1999.

(7) F. Tseng, G. Zhang, U. Frodis, A. Cohen, F. Mansfeld, and P. Will, “EFAB: High Aspect Ratio, Arbitrary 3-D Metal Microstructures using a Low-Cost Automated Batch Process”, MEMS Symposium, ASME 1999 International Mechanical Engineering Congress and Exposition, November, 1999.

(8) A. Cohen, “Electrochemical Fabrication (EFABTM)”, Chapter 19 of The MEMS Handbook, edited by Mohamed Gad-El-Hak, CRC Press, 2002.

(9) “Microfabrication-Rapid Prototyping's Killer Application”, pages 1-5 of the Rapid Prototyping Report, CAD/CAM Publishing, Inc., June 1999.

The disclosures of these nine publications are hereby incorporated herein by reference as if set forth in full herein.

The electrochemical deposition process may be carried out in a number of different ways as set forth in the above patent and publications. In one form, this process involves the execution of three separate operations during the formation of each layer of the structure that is to be formed:

1. Selectively depositing at least one material by electrodeposition upon one or more desired regions of a substrate.

2. Then, blanket depositing at least one additional material by electrodeposition so that the additional deposit covers both the regions that were previously selectively deposited onto, and the regions of the substrate that did not receive any previously applied selective depositions.

3. Finally, planarizing the materials deposited during the first and second operations to produce a smoothed surface of a first layer of desired thickness having at least one region containing the at least one material and at least one region containing at least the one additional material.

After formation of the first layer, one or more additional layers may be formed adjacent to the immediately preceding layer and adhered to the smoothed surface of that preceding layer. These additional layers are formed by repeating the first through third operations one or more times wherein the formation of each subsequent layer treats the previously formed layers and the initial substrate as a new and thickening substrate.

Once the formation of all layers has been completed, at least a portion of at least one of the materials deposited is generally removed by an etching process to expose or release the three-dimensional structure that was intended to be formed.

The preferred method of performing the selective electrodeposition involved in the first operation is by conformable contact mask plating. In this type of plating, one or more conformable contact (CC) masks are first formed. The CC masks include a support structure onto which a patterned conformable dielectric material is adhered or formed. The conformable material for each mask is shaped in accordance with a particular cross-section of material to be plated. At least one CC mask is needed for each unique cross-sectional pattern that is to be plated.

The support for a CC mask is typically a plate-like structure formed of a metal that is to be selectively electroplated and from which material to be plated will be dissolved. In this typical approach, the support will act as an anode in an electroplating process. In an alternative approach, the support may instead be a porous or otherwise perforated material through which deposition material will pass during an electroplating operation on its way from a distal anode to a deposition surface. In either approach, it is possible for CC masks to share a common support, i.e. the patterns of conformable dielectric material for plating multiple layers of material may be located in different areas of a single support structure. When a single support structure contains multiple plating patterns, the entire structure is referred to as the CC mask while the individual plating masks may be referred to as “submasks”. In the present application such a distinction will be made only when relevant to a specific point being made.

In preparation for performing the selective deposition of the first operation, the conformable portion of the CC mask is placed in registration with and pressed against a selected portion of the substrate (or onto a previously formed layer or onto a previously deposited portion of a layer) on which deposition is to occur. The pressing together of the CC mask and substrate occur in such a way that all openings, in the conformable portions of the CC mask contain plating solution. The conformable material of the CC mask that contacts the substrate acts as a barrier to electrodeposition while the openings in the CC mask that are filled with electroplating solution act as pathways for transferring material from an anode (e.g. the CC mask support) to the non-contacted portions of the substrate (which act as a cathode during the plating operation) when an appropriate potential and/or current are supplied.

An example of a CC mask and CC mask plating are shown in FIGS. 1(a) -1(c). FIG. 1(a) shows a side view of a CC mask 8 consisting of a conformable or deformable (e.g. elastomeric) insulator 10 patterned on an anode 12. The anode has two functions. FIG. 1(a) also depicts a substrate 6 separated from mask 8. One is as a supporting material for the patterned insulator 10 to maintain its integrity and alignment since the pattern may be topologically complex (e.g., involving isolated “islands” of insulator material). The other function is as an anode for the electroplating operation. CC mask plating selectively deposits material 22 onto a substrate 6 by simply pressing the insulator against the substrate then electrodepositing material through apertures 26a and 26b in the insulator as shown in FIG. 1(b). After deposition, the CC mask is separated, preferably non-destructively, from the substrate 6 as shown in FIG. 1(c). The CC mask plating process is distinct from a “through-mask” plating process in that in a through-mask plating process the separation of the masking material from the substrate would occur destructively. As with through-mask plating, CC mask plating deposits material selectively and simultaneously over the entire layer. The plated region may consist of one or more isolated plating regions where these isolated plating regions may belong to a single structure that is being formed or may belong to multiple structures that are being formed simultaneously. In CC mask plating as individual masks are not intentionally destroyed in the removal process, they may be usable in multiple plating operations.

Another example of a CC mask and CC mask plating is shown in FIGS. 1(d)-1(f). FIG. 1(d) shows an anode 12′ separated from a mask 8′ that includes a patterned conformable material 10′ and a support structure 20. FIG. 1(d) also depicts substrate 6 separated from the mask 8′. FIG. 1(e) illustrates the mask 8′ being brought into contact with the substrate 6. FIG. 1(f) illustrates the deposit 22′ that results from conducting a current from the anode 12′ to the substrate 6. FIG. 1(g) illustrates the deposit 22′ on substrate 6 after separation from mask 8′. In this example, an appropriate electrolyte is located between the substrate 6 and the anode 12′ and a current of ions coming from one or both of the solution and the anode are conducted through the opening in the mask to the substrate where material is deposited. This type of mask may be referred to as an anodeless INSTANT MASK™ (AIM) or as an anodeless conformable contact (ACC) mask.

Unlike through-mask plating, CC mask plating allows CC masks to be formed completely separate from the fabrication of the substrate on which plating is to occur (e.g. separate from a three-dimensional (3D) structure that is being formed). CC masks may be formed in a variety of ways, for example, a photolithographic process may be used. All masks can be generated simultaneously, prior to structure fabrication rather than during it. This separation makes possible a simple, low-cost, automated, self-contained, and internally-clean “desktop factory” that can be installed almost anywhere to fabricate 3D structures, leaving any required clean room processes, such as photolithography to be performed by service bureaus or the like.

An example of the electrochemical fabrication process discussed above is illustrated in FIGS. 2(a)-2(f). These figures show that the process involves deposition of a first material 2 which is a sacrificial material and a second material 4 which is a structural material. The CC mask 8, in this example, includes a patterned conformable material (e.g. an elastomeric dielectric material) 10 and a support 12 which is made from deposition material 2. The conformal portion of the CC mask is pressed against substrate 6 with a plating solution 14 located within the openings 16 in the conformable material 10. An electric current, from power supply 18, is then passed through the plating solution 14 via (a) support 12 which doubles as an anode and (b) substrate 6 which doubles as a cathode. FIG. 2(a), illustrates that the passing of current causes material 2 within the plating solution and material 2 from the anode 12 to be selectively transferred to and plated on the cathode 6. After electroplating the first deposition material 2 onto the substrate 6 using CC mask 8, the CC mask 8 is removed as shown in FIG. 2(b). FIG. 2(c) depicts the second deposition material 4 as having been blanket-deposited (i.e. non-selectively deposited) over the previously deposited first deposition material 2 as well as over the other portions of the substrate 6. The blanket deposition occurs by electroplating from an anode (not shown), composed of the second material, through an appropriate plating solution (not shown), and to the cathode/substrate 6. The entire two-material layer is then planarized to achieve precise thickness and flatness as shown in FIG. 2(d). After repetition of this process for all layers, the multi-layer structure 20 formed of the second material 4 (i.e. structural material) is embedded in first material 2 (i.e. sacrificial material) as shown in FIG. 2(e). The embedded structure is etched to yield the desired device, i.e. structure 20, as shown in FIG. 2(f).

Various components of an exemplary manual electrochemical fabrication system 32 are shown in FIGS. 3(a)-3(c). The system 32 consists of several subsystems 34, 36, 38, and 40. The substrate holding subsystem 34 is depicted in the upper portions of each of FIGS. 3(a) to 3(c) and includes several components: (1) a carrier 48, (2) a metal substrate 6 onto which the layers are deposited, and (3) a linear slide 42 capable of moving the substrate 6 up and down relative to the carrier 48 in response to drive force from actuator 44. Subsystem 34 also includes an indicator 46 for measuring differences in vertical position of the substrate which may be used in setting or determining layer thicknesses and/or deposition thicknesses. The subsystem 34 further includes feet 68 for carrier 48 which can be precisely mounted on subsystem 36.

The CC mask subsystem 36 shown in the lower portion of FIG. 3(a) includes several components: (1) a CC mask 8 that is actually made up of a number of CC masks (i.e. submasks) that share a common support/anode 12, (2) precision X-stage 54, (3) precision Y-stage 56, (4) frame 72 on which the feet 68 of subsystem 34 can mount, and (5) a tank 58 for containing the electrolyte 16. Subsystems 34 and 36 also include appropriate electrical connections (not shown) for connecting to an appropriate power source for driving the CC masking process.

The blanket deposition subsystem 38 is shown in the lower portion of FIG. 3(b) and includes several components: (1) an anode 62, (2) an electrolyte tank 64 for holding plating solution 66, and (3) frame 74 on which the feet 68 of subsystem 34 may sit. Subsystem 38 also includes appropriate electrical connections (not shown) for connecting the anode to an appropriate power supply for driving the blanket deposition process.

The planarization subsystem 40 is shown in the lower portion of FIG. 3(c) and includes a lapping plate 52 and associated motion and control systems (not shown) for planarizing the depositions.

Another method for forming microstructures from electroplated metals (i.e. using electrochemical fabrication techniques) is taught in U.S. Pat. No. 5,190,637 to Henry Guckel, entitled “Formation of Microstructures by Multiple Level Deep X-ray Lithography with Sacrificial Metal layers”. This patent teaches the formation of metal structure utilizing mask exposures. A first layer of a primary metal is electroplated onto an exposed plating base to fill a void in a photoresist, the photoresist is then removed and a secondary metal is electroplated over the first layer and over the plating base. The exposed surface of the secondary metal is then machined down to a height which exposes the first metal to produce a flat uniform surface extending across the both the primary and secondary metals. Formation of a second layer may then begin by applying a photoresist layer over the first layer and then repeating the process used to produce the first layer. The process is then repeated until the entire structure is formed and the secondary metal is removed by etching. The photoresist is formed over the plating base or previous layer by casting and the voids in the photoresist are formed by exposure of the photoresist through a patterned mask via X-rays or UV radiation.

Even though electrochemical fabrication as taught and practiced to date, has greatly enhanced the capabilities of microfabrication, and in particular added greatly to the number of metal layers that can be incorporated into a structure and to the speed and simplicity in which such structures can be made, room for enhancing the state of electrochemical fabrication exists. Electrochemical Fabrication can benefit from techniques that allow a greater range of materials to be used and from techniques that are not limited by some of the difficulties associated electrodeposition of materials.

### SUMMARY OF THE INVENTION

It is an object of various aspects of the invention to provide an electrochemical fabrication technique that uses a non-electrodeposition technique in the deposition of at least one material.

It is an object of various aspects of the invention to provide an electrochemical fabrication technique capable of depositing materials that may not be depositable using solely an electrochemical deposition process.

It is an object of various aspects of the invention to provide an electrochemical fabrication technique that uses a spray metal deposition technique to deposit at least one material during formation of at least one layer of a structure being formed.

It is an object of various aspects of the invention to provide an electrochemical fabrication technique that uses a spray metal deposition technique to fill voids in a patterned first material and then to planarize the sprayed material and the first material to a common level to achieve a desired multi-material layer that forms at least a portion of a structure being formed.

Other objects and advantages of various aspects of the invention will be apparent to those of skill in the art upon review of the teachings herein. The various aspects of the invention, set forth explicitly herein or otherwise ascertained from the teachings herein, may address one or more of the above objects alone or in combination, or alternatively may address some other object of the invention ascertained from the teachings herein. It is not necessarily intended that all objects be addressed by any single aspect of the invention even though that may be the case with regard to some aspects.

In a first aspect of the invention, a process for forming a multilayer three-dimensional structure, comprising: (a) forming and adhering a layer of material to a previously formed layer or to a substrate; (b) repeating the forming and adhering operation of (a) a plurality of times to build up a three-dimensional structure from a plurality of adhered layers; wherein the formation of at least a plurality of layers, comprises: (1) obtaining a selective pattern of deposition of a first material having voids, comprising at least one of: (a) selectively depositing a first material onto a substrate or previously formed layer such that voids remain; or (b) depositing a first material onto a substrate or previously formed layer and selectively etching the deposit of the first material to form voids therein; and (2) depositing a second material into the voids via a thermal spraying process.

In a specific variation of the first aspect of the invention after depositing via a thermal spraying process, at least one subsequent operation is used wherein modification of the second material occurs or wherein adhesion between the second material deposited in association with one layer and material deposited in association with another layer is enhanced. In a specific variation of the second aspect of the invention the formation of the plurality of layers additionally includes at least two planarization operations on each of at least a portion of the plurality of layers.

In a second aspect of the invention, a process for forming a multilayer three-dimensional structure, comprising: (a) forming and adhering a layer of material to a previously formed layer or to a substrate; (b) repeating the forming and adhering operation of (a) a plurality of times to build up a three-dimensional structure from a plurality of adhered layers; wherein the formation of at least a plurality of layers, comprises: (1) obtaining a selective pattern of deposition of a first material having voids, comprising at least one of: (a) selectively depositing a first material onto a substrate or previously formed layer such that voids remain; or (b) depositing a first material onto a substrate or previously formed layer and selectively etching the deposit of the first material to form voids therein; and (2) depositing a second material into the voids; (3) etching the deposit of the first material or second material to form second voids; and (4) depositing a third material into the second voids via a thermal spraying process.

In specific variations of the first and second aspects of the invention the formation of the plurality of layers additionally includes at least one planarization operation on each of at least a portion of the plurality of layers.

In specific variations of the first and second aspects of the invention the thermal spraying process includes at least one of: (1) an arc wire spraying process, (2) a high velocity oxygen-fuel (HVOF) spraying process, (3) a plasma spraying process, (4) a plasma transferred arc (PTA) spraying process, (5) a vacuum or low pressure plasma spraying, (6) a low velocity oxygen-fuel (LVOF) spraying process, (7) detonation thermal spraying process, (8) a high velocity particle consolidation (HVPC) spraying process, or (9) a wire spraying process, or (10) an ion plating process.

In specific variations of the first and second aspects of the invention after depositing via a thermal spraying process an infiltration process is used to fill any surface voids with a third material.

In a third aspect of the invention a process for forming a multilayer three-dimensional structure, comprising: (a) forming and adhering a layer of material to a previously formed layer or to a substrate; (b) repeating the forming and adhering operation of (a) a plurality of times to build up a three-dimensional structure from a plurality of adhered layers; wherein the formation of at least a plurality of layers, comprises: (1) obtaining a selective pattern of deposition of a first material having voids, comprising at least one of: (a) selectively depositing a first material onto a substrate or previously formed layer such that voids remain; or (b) depositing a first material onto a substrate or previously formed layer and selectively etching the deposit of the first material to form voids therein; and (2) depositing a second material into the voids wherein the second material prior to deposition comprises a powder.

In a fourth aspect of the invention a process for forming a multilayer three-dimensional structure, comprising: (a) forming and adhering a layer of material to a previously formed layer or to a substrate; (b) repeating the forming and adhering operation of (a) a plurality of times to build up a three-dimensional structure from a plurality of adhered layers; wherein the formation of at least a plurality of layers, comprise: (1) obtaining a selective pattern of deposition of a first material having voids, comprising at least one of: (a) selectively depositing a first material onto a substrate or previously formed layer such that voids remain; or (b) depositing a first material onto a substrate or previously formed layer and selectively etching the deposit of the first material to form voids therein; and (2) depositing a second material into the voids; (3) etching the deposit of the first material or second material to form second voids; and (4) depositing a third material into the second voids, wherein the third material prior to deposition comprises a powder.

In specific variations of the third and fourth aspects of the invention wherein the material including the powder, further includes at least one of (1) at least two powders of different materials, (2) at least two powders with different particle size distributions, (3) a liquid carrier for the powder, (4) a transformable binder that can be used to bind the powder particles, or (5) a liquid carrier that can be transformed by radiation, heat, pressure, or chemical means to bind the powder particles.

Further aspects of the invention will be understood by those of skill in the art upon reviewing the teachings herein. Other aspects of the invention may involve combinations of the above noted aspects of the invention. Other aspects of the invention may involve apparatus that can be used in implementing one or more of the above method aspects of the invention. These other aspects of the invention may provide various combinations of the aspects presented above as well as provide other configurations, structures, functional relationships, and processes that have not been specifically set forth above.

### BRIEF DESCRIPTION OF THE DRAWINGS

FIGS. 1(a)-1(c) schematically depict side views of various stages of a CC mask plating process, while FIGS. 1(d)-(g) schematically depict a side views of various stages of a CC mask plating process using a different type of CC mask.

FIGS. 2(a)-2(f) schematically depict side views of various stages of an electrochemical fabrication process as applied to the formation of a particular structure where a sacrificial material is selectively deposited while a structural material is blanket deposited.

FIGS. 3(a)-3(c) schematically depict side views of various example subassemblies that may be used in manually implementing the electrochemical fabrication method depicted in FIGS. 2(a)-2(f).

FIGS. 4(a)-4(i) schematically depict the formation of a first layer of a structure using adhered mask plating where the blanket deposition of a second material overlays both the openings between deposition locations of a first material and the first material itself

FIGS. 5(a)-5(e) illustrate various operations associated with a first embodiment of the invention.

FIGS. 6(a)-6(h) illustrate various operations associated with a second embodiment of the invention.

FIGS. 7(a)-7(h) illustrate various operations associated with a third embodiment of the invention.

FIGS. 8(a) and 8(b) illustrate additional steps that may be incorporated into the layer formation process of FIGS. 6(a)-6(h) to cause infiltration of the third deposited material with a fourth material.

FIGS. 9(a)-9(d) illustrate additional steps that may be incorporated into the formation of a multi-layer structure to cause infiltration of a porous material as a post layer formation process.

### DETAILED DESCRIPTION OF PREFERRED EMBODIMENTS OF THE INVENTION

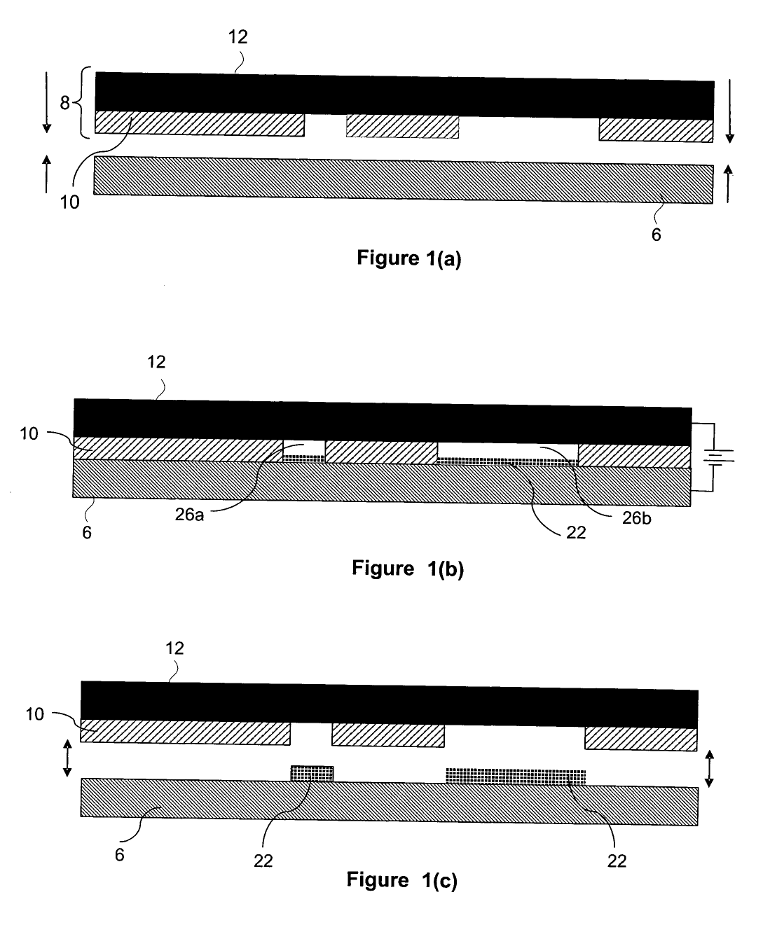

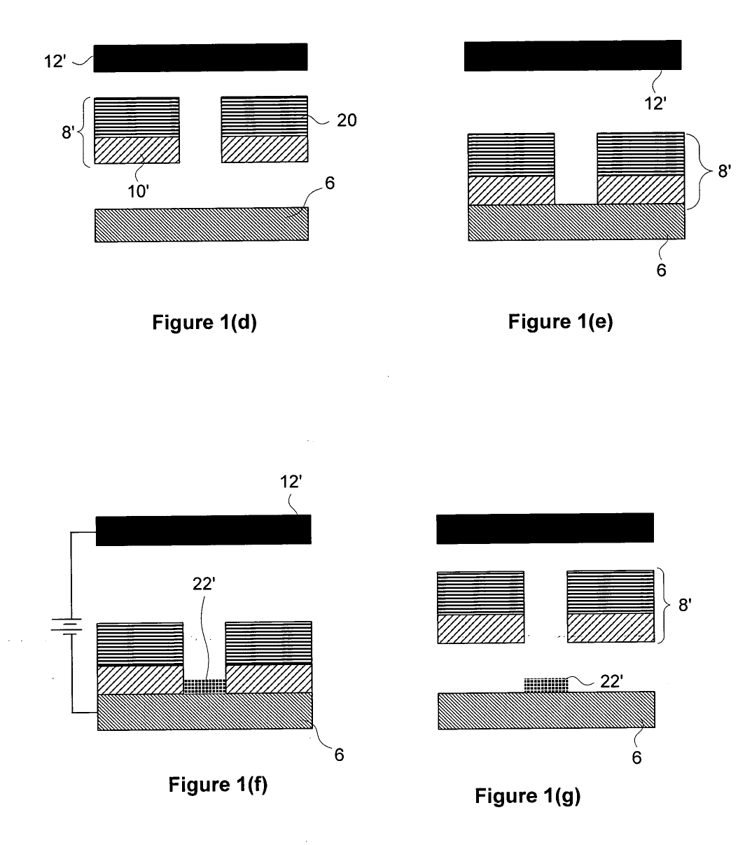

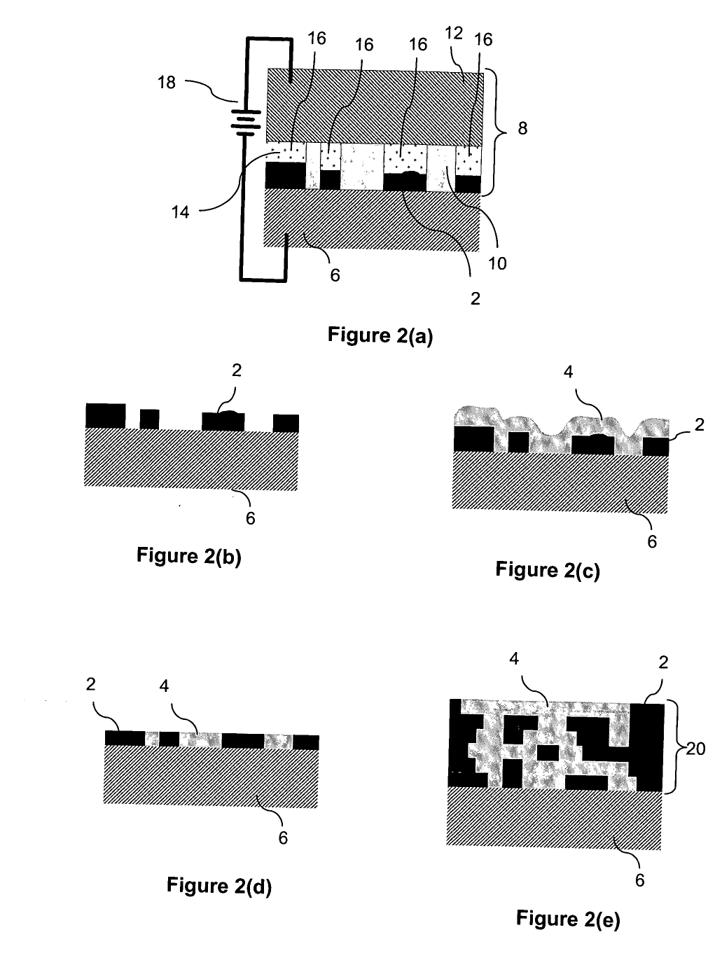

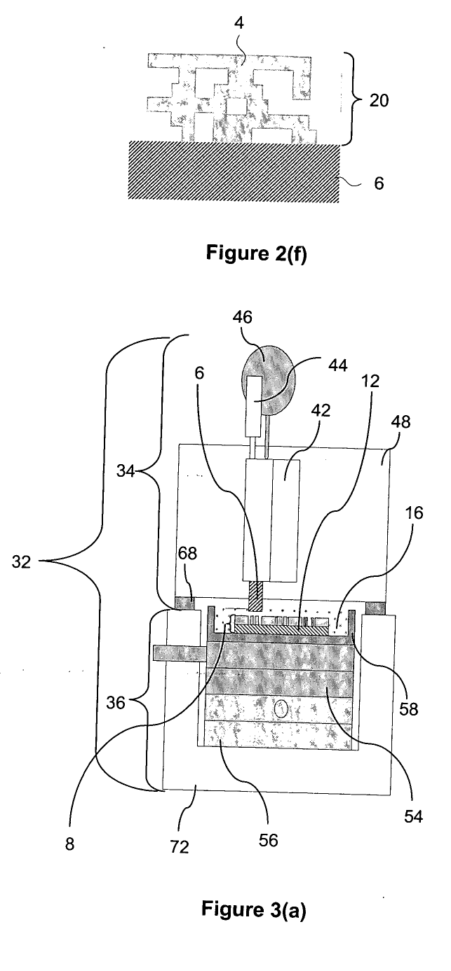

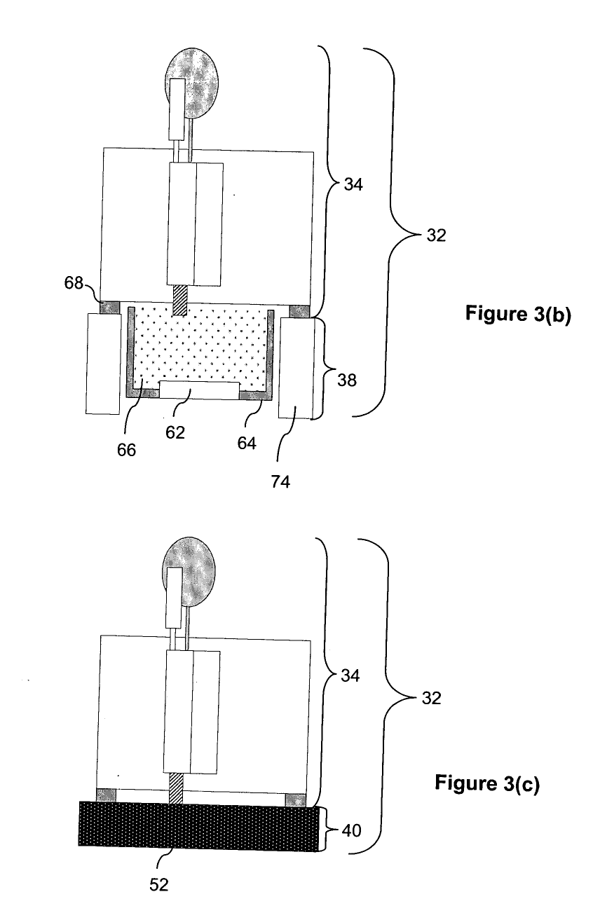

FIGS. 1(a)-1(g), 2(a)-2(f), and 3(a)-3(c) illustrate various features of one form of electrochemical fabrication that are known. Other electrochemical fabrication techniques are set forth in the '630 patent referenced above, in the various previously incorporated publications, in various other patents and patent applications incorporated herein by reference, still others may be derived from combinations of various approaches described in these publications, patents, and applications, or are otherwise known or ascertainable by those of skill in the art from the teachings set forth herein. All of these techniques may be combined with those of the various embodiments of various aspects of the invention to yield enhanced embodiments. Still other embodiments may be derived from combinations of the various embodiments explicitly set forth herein.

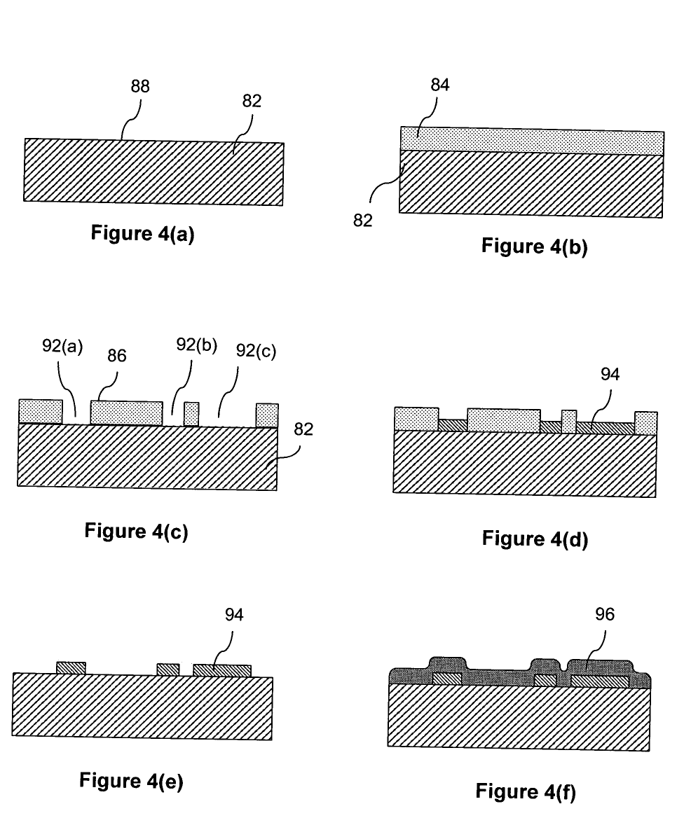

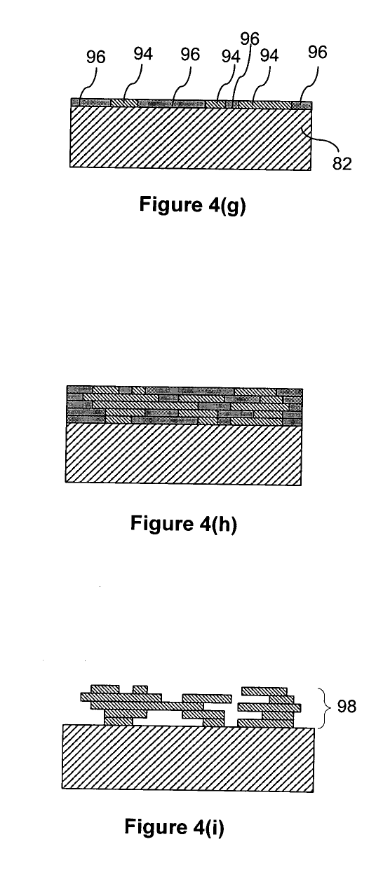

FIGS. 4(a)-4(i) illustrate various stages in the formation of a single layer of a multi-layer fabrication process where a second metal is deposited on a first metal as well as in openings in the first metal where its deposition forms part of the layer. In FIG. 4(a), a side view of a substrate 82 is shown, onto which patternable photoresist 84 is cast as shown in FIG. 4(b). In FIG. 4(c), a pattern of resist is shown that results from the curing, exposing, and developing of the resist. The patterning of the photoresist 84 results in openings or apertures 92(a)-92(c) extending from a surface 86 of the photoresist through the thickness of the photoresist to surface 88 of the substrate 82. In FIG. 4(d), a metal 94 (e.g. nickel) is shown as having been electroplated into the openings 92(a)-92(c). In FIG. 4(e), the photoresist has been removed (i.e. chemically stripped) from the substrate to expose regions of the substrate 82 which are not covered with the first metal 94. In FIG. 4(f), a second metal 96 (e.g., silver) is shown as having been blanket electroplated over the entire exposed portions of the substrate 82 (which is conductive) and over the first metal 94 (which is also conductive). FIG. 4(g) depicts the completed first layer of the structure which has resulted from the planarization of the first and second metals down to a height that exposes the first metal and sets a thickness for the first layer. In FIG. 4(h) the result of repeating the process steps shown in FIGS. 4(b)-4(g) several times to form a multi-layer structure are shown where each layer consists of two materials. For most applications, one of these materials is removed as shown in FIG. 4(i) to yield a desired 3-D structure 98 (e.g. component or device).

The various embodiments, alternatives, and techniques disclosed herein may be used in combination with electrochemical fabrication techniques that use different types of patterning masks and masking techniques or even techniques that perform direct selective depositions without the need for masking. For example, conformable contact masks and masking operations may be used, proximity masks and masking operations (i.e. operations that use masks that at least partially selectively shield a substrate by their proximity to the substrate even if contact is not made) may be used, non-conformable masks and masking operations (i.e. masks and operations based on masks whose contact surfaces are not significantly conformable) may be used, and adhered masks and masking operations (masks and operations that use masks that are adhered to a substrate onto which selective deposition or etching is to occur as opposed to only being contacted to it) may be used.

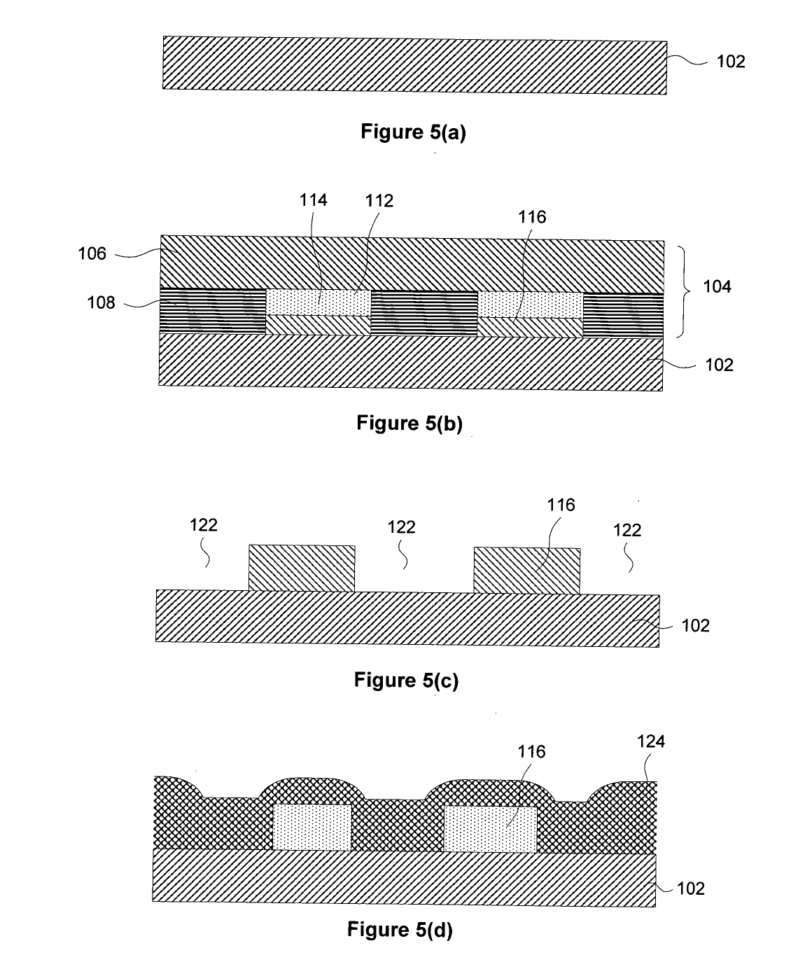

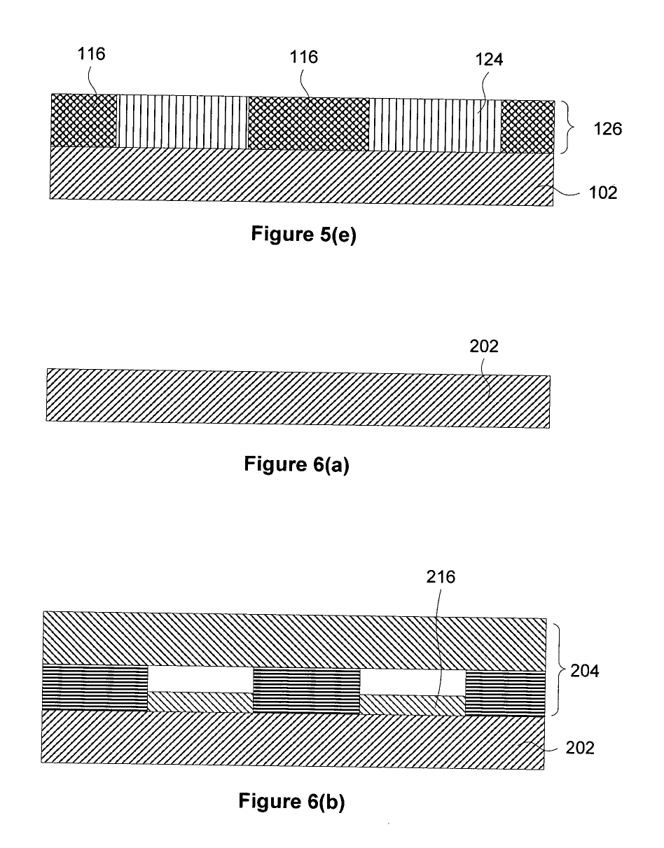

The first embodiment of the present invention is illustrated in FIGS. 5(a) -5(e). The process starts with a substrate 102 on which layers of material will be deposited. This substrate is shown in FIG. 5(a). FIG. 5(b) illustrates a conformable contact mask 104 in contact with substrate 102. The conformable contact mask 104 includes a support portion 106 and a conformable portion 108. The conformable portion includes voids 112 through which material may be deposited onto substrate 102. Voids 112 are filled with electrolyte 114 during the deposition process.

When the support and substrate are properly placed a current will cause deposition of first material 116 onto the substrate. This deposition process occurs until a desired height of deposition is achieved. FIG. 5(b) illustrates deposit 116 being partially formed. FIG. 5(c) illustrates fully formed deposit 116 on substrate 102 once separated from the contact mask 104. FIG. 5(d) depicts the result of a blanket deposition of a second material 124 that fills the voids 122 that were not filled by the first material during the selective deposition of first material 116. The second material is also located above the selectively deposited first material 116.

FIG. 5(e) depicts the deposits of the first and second materials after a planarization operation is used to bring them to a common level. Additional layers of material may be formed adjacent to first layer 126 by repeating the operations illustrated in FIGS. 5(b)-5(e). Of course, in other embodiments, different operations may be substituted for some or all of the operations shown in FIGS. 5(b)-5(e) at least for some layers.

In some alternative embodiments, the selective deposition process of FIG. 5(b) may replace the conformable contact mask with an adhered mask having openings through which material may be selectively plated onto the substrate.

The blanket deposition of the second material preferably occurs by a spraying process (e.g. a thermal spraying process—a group of processes in which finely divided metallic or nonmetallic coating materials are deposited in a molten or semi-molten state on to a substrate—the coating materials may be provided in a variety of forms) or a powder deposition process. Various spraying processes may be used. An example of one such process is called Arc Wire Spraying or Arc Spraying (ASP). In this process an arc is struck between two conducting wires and the molten material resulting from the arc is subjected to a stream of compressed gas that directs the molten material to a target surface (i.e. the substrate or previously formed layer or portion of a layer). Arc Wire Spraying may be done in air, in a vacuum chamber or in a chamber containing a selected gas (e.g. an inert gas).

An example of a second spraying process that may be used is High Velocity Oxygen-Fuel spraying (HVOF) which is a technique within the class of Flame Spraying. Flame spraying is a class of processes in which an oxygen fuel gas flame is the source of heart for melting the coating material and compressed gas may or may not be used to atomize and/or propel the coating material to a substrate. In the HVOF process powder particles are injected into a high velocity stream of gas which is produced by the combustion of a fuel and oxygen. The powder particles are heated and accelerated by the stream to a target surface that is to receive the coating.

An example of a third spraying process that may be used falls within a class of processes known as Plasma Spraying and in these process plasma is created by forming an arc between an anode and a cathode (neither of which is the substrate) in the presence of a gas which is made to flow there between. The deposition material may be in the form of a powder which is injected into the plasma stream. The plasma stream directs the molten particles to the target surface.

An example of a fourth spraying process that may be used is known as Plasma Transferred Arc (PTA) spraying. In this process the target surface is treated as an electrode at which the plasma is directed. This creates a hot surface for powder contact.

An example of a fifth spraying process that may be used is known as vacuum or low pressure plasma spraying. This process is carried out in a controlled chamber that has been evacuated to a low partial pressure of oxygen. The chamber is then back-filled with an inert gas such as argon. Afterwards, an arc is used to create the plasma that directs the molten material to the target surface.

An example of a sixth spraying process that may be used is known as Low Velocity Oxygen Fuel (LVOF) spraying which is another technique within the class of Flame Spraying. In this process a powdered material is directed into a spray of combusting oxygen and fuel. The powder material is melted by the combusting fuel to form a fine spray. The spray is directed onto the surface of the target and the very small molten droplets rapidly solidify to form a desired coating. This process is also known as a cold process, in that the temperature of the target surface may be kept low during coating.

An example of a seventh spraying process that may be used is known as a detonation spraying (D-Gun) process in that a mixture of oxygen, fuel and powderized deposition material are located in a combustion tube (e.g. gun barrel) to which a spark is applied which detonates the mixture. This causes heated deposition material to be shot out of the tube onto the target surface. After each detonation operation a gas such as nitrogen may be used to purge the tube. Thereafter, additional oxygen, fuel, and powder are loaded into the chamber in anticipation of another igniting spark. This process may be repeated numerous times per second until a desired coating depth are obtained. This process may be used to build very dense coatings.

ASM International, Materials Engineering Institute publishes a course (Course 530, formerly Course 51) entitled Thermal Spray Technology copyrighted 1992 which provides more detail on the various thermal spray techniques disclosed herein and is incorporated herein by reference in its entirety. This course is available from ASM International of Materials Park, Ohio. This course consists of six lessons (1) “Surface Science” by Thomas Bernecki, (2) “Equipment and Theory” by Ronald W. Smith, (3) “Processing and Design” by Frank N. Longo, (4) “Mateirals Production for Thermal Spray Processes” by Christopher C. Berndt, (5) “Selected Applications” by Doug H. Harris, and (6) “Testing and Characterization” by Walter L Riggs II; and a Thermal Spray Technology Glossary.

Another example of a spraying process that may be used is known as high velocity particle consolidation and has been developed by Penn State University. In this process solid particles are directed onto a target surface at supersonic speeds (e.g. 300-1000 meters per second). In this process the particles may have diameters as large as 1-50 millimeters and it is intended that the particles impact the target surface while still in a solid state, whereas in the other thermal spray processes, the particles are in a molten state at the time of impact.

Another set of examples of spraying processes, that may be used, exchange the powder feedstock of some of the above processes with a wire feedstock.

A further set of examples of spraying processes that may be used exchange the powder or wire feedstock for a molten feedstock. One such process is known as Rapid Solidification Processing (RSP) and was developed at the Idaho National Engineering and Environmental Laboratory. The process is described in U.S. Pat. Nos. 6,074,194 and 5,718,863 by Kevin McHugh et al. These patents are incorporated herein by reference as if set forth in full. This process has focused on the formation of near-net shape molds, dies, and related tooling. It involves depositing material onto the surface of a three-dimensional base structure to form a coating thereon. After coating formation, the base structure is removed to yield a complementary pattern in the deposited material. In this process molten materials (e.g. metals) are formed into droplets of an aerosol spray by means of suction into a Venturi tube. The metal droplets, when they impact a working surface, are of a temperature that is at or below their melting temperature, and are cooled rapidly to the solid state by thermal conduction through the substrate. It is believed that full density deposits can be achieved with potentially reduced substrate damage when compared to some other spraying techniques. It is believed that this process may be used to deposit alloys, polymers, and even composite materials. For example, the deposition of composite material may occur by combining the deposition of atomized droplets with solid elements such as powders, whiskers or fibers.

Another group of processes that can be used in depositing material is known as Ion Plating or Vacuum Arc Deposition. These processes operate more like an electron beam evaporator or sputter deposition process than a spraying process, but they can achieve much higher deposition rates (0.5-1 μm/minute) than most other vacuum thin film deposition techniques. These systems may operate by creating a high current DC arc discharge in a vacuum chamber between an inert cathode and an erosion target. A plasma is created and is sustained by vaporization of metal atoms from the target surface. In these processes, enhanced plating may occur by biasing deposition to a surface such that a larger portion of a deposition material is directed to the deposition surface than mere randomness would dictate. Focusing of a stream of deposition material onto the deposition surface may occur, for example via application of a magnetic field that directs ionized material along a path that intersects the deposition surface or via application of a potential that pulls ionized particles toward the deposition surface. In some embodiments, the flux of material toward the substrate (i.e. the deposition surface) may be cleaned up by causing the deposition surface to be located in a non-line of sight position relative to any target surface from which sputtered material is extracted.

A further group of processes for applying a material to a desired surface involves application of a powder material and then pressing the powder (e.g. via hot pressing) to reduce porosity of the applied materials. Some of these processes combine high pressures with high temperatures and are known as Hot Isostatic Pressing (HIP). Other processes use pressure alone and are known as Cold Isostatic Pressing, while other use intermediate temperatures and are known as Warm Isostatic Pressing. In HIP, the combination of pressure and temperature enhances ductile flow for particle consolidation and mold pattern filling. The HIP processes may, for example, use temperatures that are around 60-70% of the melting point of the powder material.

One EFAB process using such a technique may involve the following steps: (1) deposit and pattern a layer of a first material, e.g. copper using an instant mask where the deposition thickness is equal to but more preferably somewhat greater than a desired layer thickness, (2) using a blanket deposition process to cover the whole pattern with a powder, e.g. with a powder of stainless steel at a thickness of 30-50 μm for a 4-10 μm layer thickness, (3) heating the deposited material, e.g. to about 60-70% of the melting temperature of the powder material, and uniformly pressing the structure to bond and enhance the density of the powder material in the shape defined by the first material, (4) planarizing the resulting structure to a desired height, e.g. to the layer thickness, and (5) repeating steps (1)-(4) a plurality of times to build up a structure from a plurality of layer. If desired, once the structure is formed, removal of at least one of the deposited materials may occur to release a desired structure.

In still other embodiments, instead of using HIP, CIP, or the like to compress a powder material, a back filling process may be used to infiltrate a flowable material into the pours of the powder material. An example of such a process is the 3D Keltool process of 3D Systems, Inc. of Valencia Calif. which involves the following steps (1) a slurry is formed which includes a powder material and an epoxy binder, (2) the slurry is pressed against a desired pattern that is to be replicated, (3) the binder is cured producing a “green part”, (4) the green part is separated from the patterning surface, (4) the green part is then placed in a hydrogen reduction furnace where the powder particles become sintered and the binder is burned off resulting in a porous structure which is known as a brown part, and (5) the pores in the brown part are finally infiltrated with a molten metal. Variations of this process are described in the following US Patents which are hereby incorporated herein by reference: (1) U.S. Pat. No. 3,823,002, entitled “Precision Molded Refractory Articles,” issued July 1974 to Kirby et al.; (2) U.S. Pat. No. 3,929,476, entitled “Precision Molded Refractory Articles and Method of Making,” issued December 1975 to Kirby et al.; (3) U.S. Pat. No. 4,327,156, entitled “Infiltrated Powdered Metal Composites Article,” issued April 1982 to Dillon et al.; (4) U.S. Pat. No. 4,373,127, entitled “EDM Electrodes,” issued February 1983 to Hasket et al.; (5) U.S. Pat. No. 4,432,449, entitled “Infiltrated Molded Articles of Spherical Non-Refractory Metal Powders,” issued February 1984 to Dillon et al.; (6) U.S. Pat. No. 4,455,354, entitled “Dimensionally-Controlled Cobalt Containing Precision Molded Metal Article,” issued June 1984 to Dillon et al.; (7) U.S. Pat. No. 4,469,654, entitled “EDM Electrodes,” issued September 1984 to Hasket et al.; (8) U.S. Pat. No. 4,491,558, entitled “Austenitic Manganese Steel Containing Composite Article,” issued January 1985, to Gardner; (9) U.S. Pat. No. 4,554,218, entitled “Infiltrated Powdered Metal Composite Article,” issued November 1985, to Gardener et al.; (10) U.S. Pat. No. 5,507,336, entitled “Method of Constructing Fully Dense Metal Molds and Parts,” issued to Tobin; and (10) U.S. Pat. No. 6,224,816, entitled “Molding Method, Apparatus, and Device Including Use of Powder Metal Technology for Forming a Molding Tool with Thermal Control Elements”, issued May 2001, to Hull, et al.

As typically used, the 3D Keltool process starts with placing the slurry around a three-dimensional pattern of RTV where initial shaping is locked in by curing of the epoxy binder where after the RTV is removed and all subsequent processes are then performed.

When using such techniques with EFAB, the solidification of the binder material may occur on a layer-by-layer basis while the removal of the binder and sintering of the particles may occur either on a layer-by-layer basis or after formation of all layers. The sintering and/or removal of the binder may occur before or after the release of the structure from a sacrificial material. It is believed that if conductive powders or fillers are used along with sufficiently high packing densities and if layers are planarized it is probable that sufficient electrical conductive over the surface of the bounded powder will exist to allow electroplating over the surface to occur without the need for seed layers, and seed layer removal operations and the like. It is possible also to include conductive strings or fibers within the powder material to aid in establishing continuity. However, if necessary or desired such additional operations may be used.

In a further processes, a combination of the binder based powder and isostatic pressing maybe used. The initial application of a slurry of powder/binder may be placed over the molded layer pattern, the powder may be sintered and the binder removed, and thereafter isostatic pressing used to cause full or partial compaction. If necessary, an infiltration step may still be used.

The deposition or application of powders may occur in a variety of ways, for example they may be sprayed, blown, poured, sifted, swept, electrophoretically transferred, squeegeed (e.g. if they are with a liquid carrier, or the like). The powders may comprise a single material with a relatively uniform particle size, multiple materials, and particles of similar or different materials with different distributions of particles sizes or shapes. The particles may be transferred in a dry or liquid state (e.g. as part of a slurry). Some particles, some portions of individual particles, or a liquid carrier may be a binding material. The binding material may set; (1) over time, (2) as a result of pressure, (3) as a result of exposure to selected chemicals, (4) as a result of exposure to radiation, (5) as a result of exposure to heat, or the like.

If a binding material accompanies the application of the powder material, it may become a permanent part of a structure or it may act only as a temporary manufacturing facilitator.

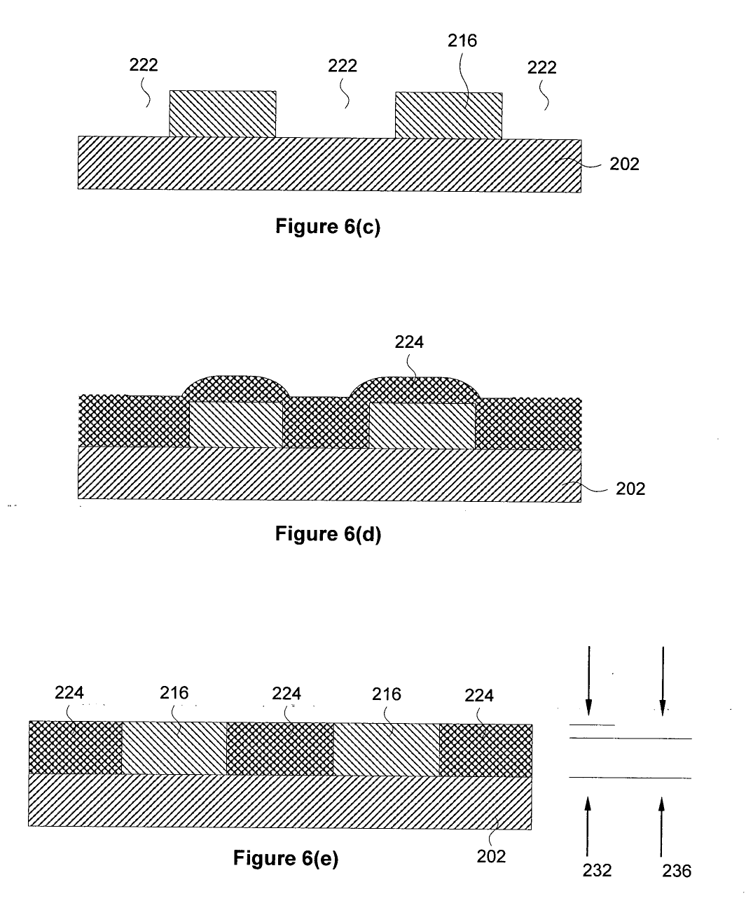

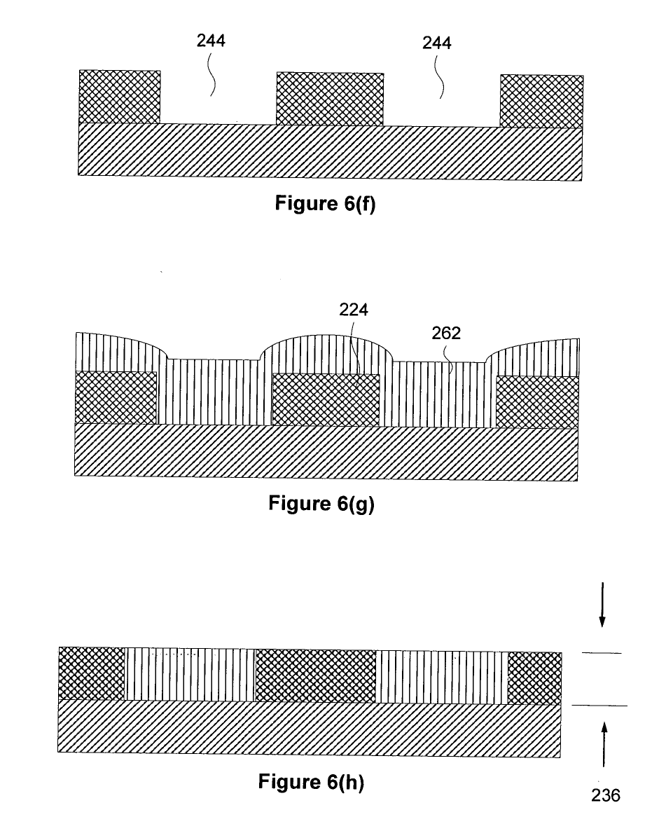

A second embodiment of the present invention is illustrated in FIGS. 6(a)-6(h). FIG. 6(a) illustrates substrate 202 upon which a first layer of structure to be formed will be deposited. FIG. 6(b) is similar to FIG. 5(b) of the first embodiment in that a conformable contact mask 204 is shown mated with substrate 202 for the purpose of forming a deposition 216. FIG. 6(c) is similar to FIG. 5(c) in that a completed deposition 216 is shown on substrate 202.

In FIG. 6(d) a second material is shown blanket deposited into the voids 222 which did not receive material 216. The second material is also shown as deposited over depositions 216. The second material 224 in FIG. 6(d) may be a material that could not be readily electrodeposited using a conformable contact mask or could not be readily deposited via electrodeposition at all. For example, the material might be a refractive material such as tungsten or tantalum. Such refractory material may be deposited from a solution of molten salts as discussed in U.S. Pat. No. 3,444,058, entitled “Electrodeposition of Refractory Metals” and issued to Geoffrey Mellors et al. This patent is hereby incorporated by reference as if set forth in full herein.

The next operation in the process of the second embodiment is to planarize the two materials 224 and 216 so that both materials have a common level. This planarization process may place the surface of the deposits at a thickness 232 which is somewhat greater then a desired thickness 236 for the layer as illustrated in FIG. 6(e). This greater thickness may be only slightly greater than the layer thickness so as to ensure that any tolerance in the this planarization operation or a subsequent planarization operation do not cause undesired results (e.g. thin regions of the second deposited material over the first deposited material or a third deposited material over the first or second deposited materials). Alternatively, the greater thickness may be selected to be large enough such that any process damage that results from a third deposit to be made will not extend into the first or second materials to a depth that will not be removed when the entire surface is planarized to the layer thickness.

FIG. 6(f) illustrates a next operation in the process where an etching operation is used to selectively remove the first deposited material. For example, if the first deposited material was copper and the second deposited material was nickel a useful selective etchant might be C38.

A next operation is depicted in FIG. 6(g) where a blanket deposition of a third material is made to fill voids 244 as well as to cover deposits 224. The third material 262 may be deposited by an appropriate process (e.g. thermal spraying process or powder deposition process). This process might be used to deposit, for example, titanium or stainless steel (e.g. 316L). FIG. 6(h) illustrates the completed formation of a first layer that results from a planarization operation that brings the surface level of deposited materials 224 and 262 to a desired common level such that a thickness 236 is achieved. The planarization operation may be performed by lapping, machining, chemical mechanical polishing (CMP), or any other operations that can achieve the desired resolution. The planarization technique preferably doesn't result in any significant smear of the one material into another material at the interfaces of the multiple materials particularly when a significant hardness difference exists.

The processes of FIGS. 6(b)-6(h) may be repeated a plurality of times to add additional layers to the substrate to form an object of desired configuration.

In some alternative embodiments, the selective deposition process of FIG. 6(b) may replace the conformable contact mask with an adhered mask having openings through which material may be selectively plated onto the substrate.

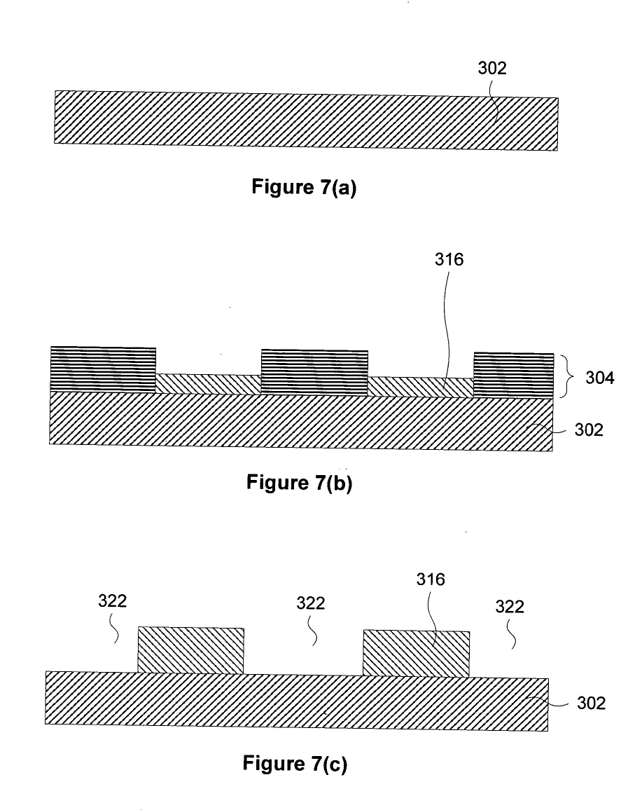

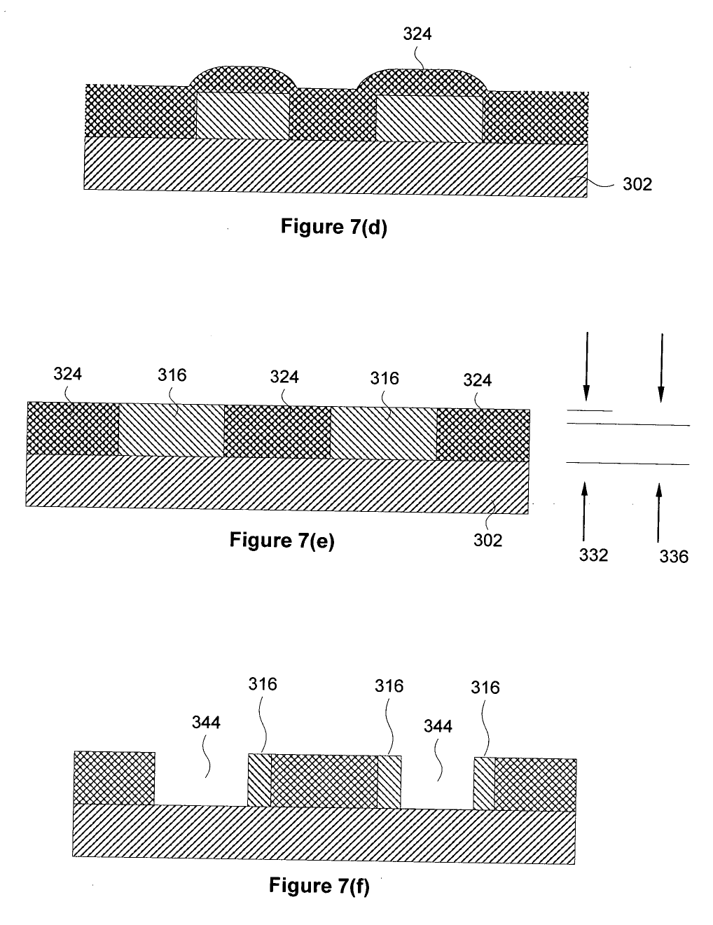

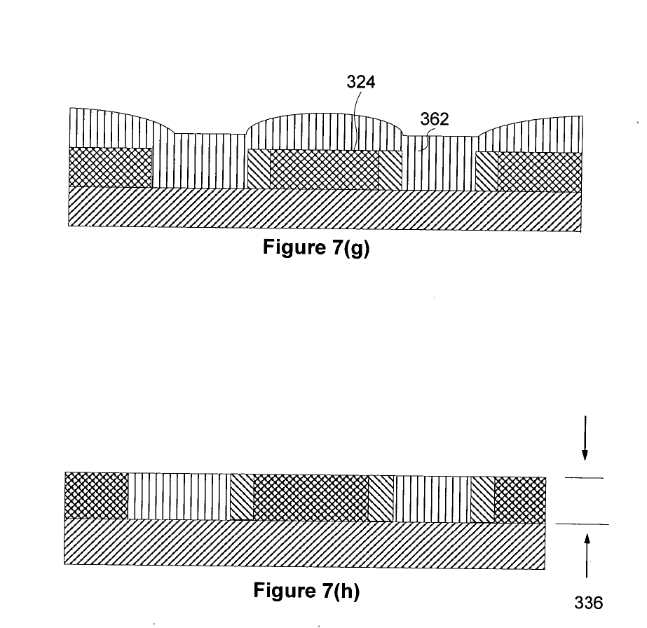

FIGS. 7(a)-7(h) illustrate various operations associated with a third embodiment of the invention.

The third embodiment begins by providing a substrate 302. A mask 304 is formed on the substrate (e.g. an adhered mask) and deposition from an anode 312 to substrate (cathode) 302 is performed.

In FIG. 7(b) the deposition 316 is shown as being partially formed.

FIG. 7(c) illustrates the process after the deposition of material 316 has been completed and the mask 304 removed to reveal voids 322.

FIG. 7(d) illustrates the state of the process after a second material 324 is blanket deposited over the substrate 302 and previously deposited material 316.

FIG. 7(e) shows the state of the process after the deposited first and second materials are planarized to a level which sets the thickness 332 to a level which is greater then the desired thickness 336 of a layer being formed.

FIG. 7(f) shows the state of the process after material 316 has been selectively etched into to form voids 344. The selective etching of material 316 may occur by use of a masking material that covers the portions of material 316 that are to remain and may also cover the material 324.

FIG. 7(g) depicts the state of the process after deposition of a third material 362 fills voids 344.

FIG. 7(h) depicts the state of the process after the first through third materials have been planarized to the desired layer thickness. The structure of FIG. 7(h) depicts the completed layer and is capable of accepting additional layers that are necessary to complete formation of a structure.

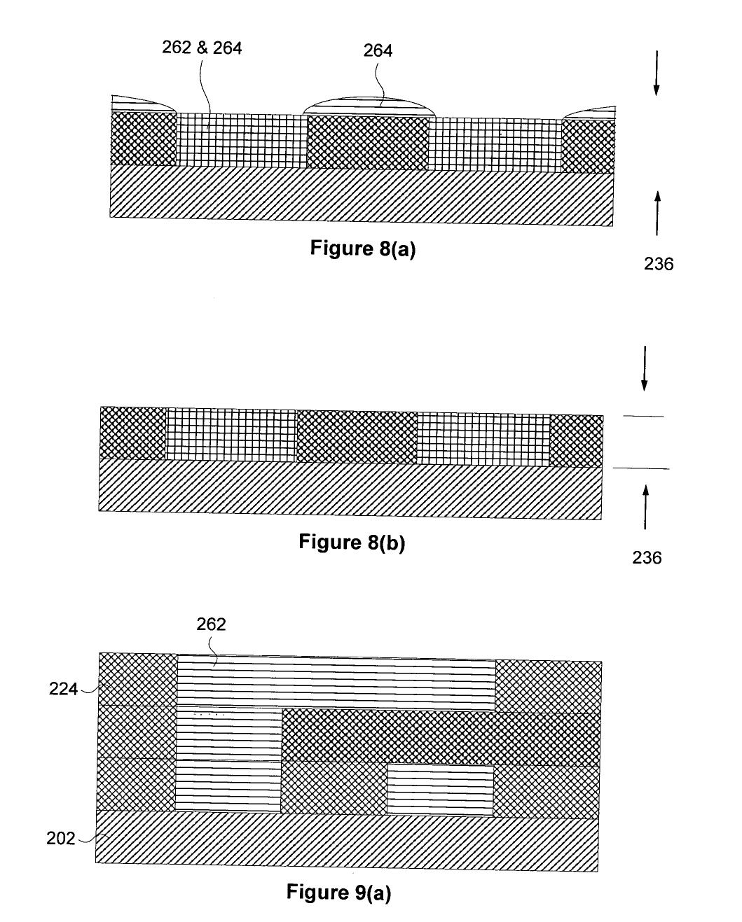

FIGS. 8(a) and 8(b) illustrate additional steps that may be incorporated into the layer formation process of FIGS. 6(a)-6(h) to cause infiltration of the third deposited material with a fourth material.

FIG. 8(a) shows the state of the process after the structure of FIG. 6(h) receives a deposit of an infiltrating material 264. The material 264 does not infiltrate material 224 as it is assumed material 224 is non-porous. However, material 264 does fill voids in material 262 as it is assumed material 262 is porous. Material 264, for example, may be a melted metal (e.g. copper or bronze) it is also assumed that since this added infiltration step was to be preformed the height 234 of the planarized materials, prior to application of infiltrant 264 may be different from the layer thickness 236 (e.g. height 234 may be greater than height 236).

FIG. 8(b) depicts the state of the process after the deposited material has been planned to the layer thickness 236 leaving behind regions containing material 224 and regions containing a composite of materials 262 and 264.

In still other embodiments, the infiltration processes of FIGS. 8(a)-8(b), may be applied to structures that include porous materials that were formed with additional materials or that were formed using alternatives processes.

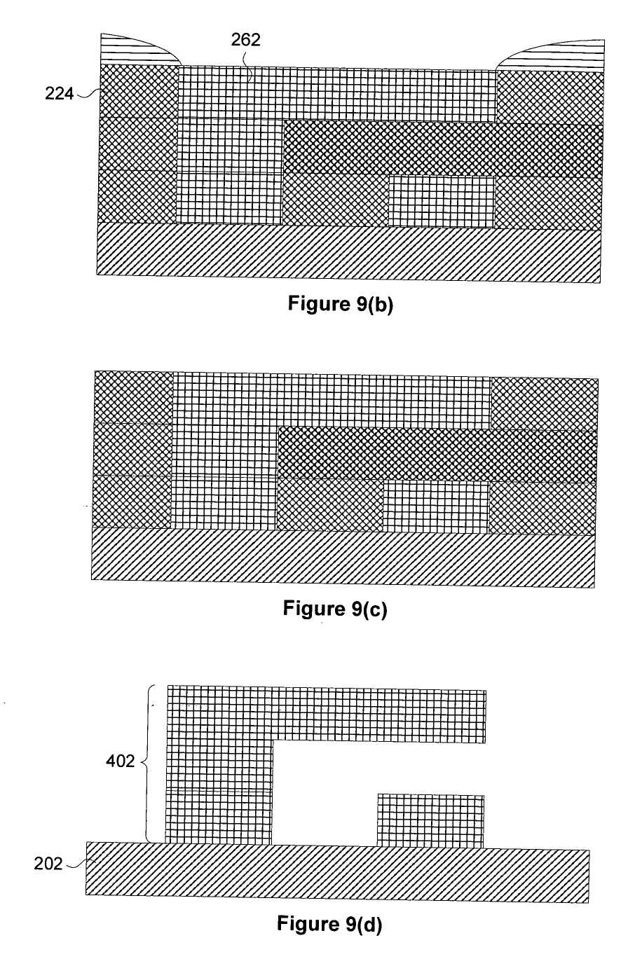

FIGS. 9(a)-9(d) illustrate additional steps that may be incorporated into the formation of a multi-layer structure to cause infiltration of a porous material as a post layer formation process.

FIG. 9(a) depicts a three layer structure sitting on substrate 202 which comprises material 224 and material 262. It is assumed that material 224 is non-porous and that material 262 is porous and is capable of accepting an infiltrant.

FIG. 9(b) depicts the state of the process after an infiltrant 264 is applied to the upper surface of the structure. The infiltrant is not only located above the structure but also fills the pores in material 262.

FIG. 9(c) shows the state of the process after a planarization operation removes excess infiltrant from the upper surface of the structure.

FIG. 9(d) depicts the state of the process after a release operation removes material 224 leaving behind released structure 402 on substrate 202.

In some alternatives to the embodiment of FIG. 9(a)-9(d), the porous structural material may be released from the sacrificial material prior to infiltration using one of the infiltration limiting techniques disclosed in the above noted patents associated with the Keltool process. In still other embodiments, the infiltration processes of FIGS. 9(a)-9(b), and its post-release alternatives, may be applied to structures that include porous materials that were formed with additional materials or that were formed using alternatives processes.

In some alternative embodiments, instead of removing part of the first material as illustrated in FIG. 7(f), the regions to be etched may have been designed into the regions occupied by the second deposited material. In still other embodiments, the regions to be etched may be occupied by a region that includes a combination of first and second materials. In still further embodiments, instead of etching to obtain void regions for accepting the third material the void regions may result from a selective deposition of the second material.

In some embodiments the powder materials deposited may be conductive materials (e.g. various metals) or they may be dielectric materials (e.g. polymers, ceramics and the like).

In other embodiments additional selective and blanket plating operations may be used, additional etching operations may be used and additional planarization or leveling operations may be used. The additional etching operations may be of a selective nature either as a result of a masking operation or the like or they may be selective by virtue of a chemical reaction or dissolution process that favors one of the deposited materials as compared to one or more of the other deposited materials. In some embodiments one or more of the deposited materials may be separated from the other materials to yield the released structure of desired configuration. In some embodiments, either on a layer-by-layer basis or after formation of the entire structure or after release of the desired structure additional operations may be performed to improve the resulting final product or to improve the formation process itself.

For example, prior to application of the second material of the first embodiment or the third material of the second embodiment, deposits 116 and 216 may be treated so as to harden or otherwise modify their surfaces so that they may better tolerate a specific spray metal deposition process. For example, the surface of the deposits may be hardened by heating and rapid cooling. The surfaces may be modified by deposition of a harder material. The surfaces 116 and 216 may undergo an oxidation process for example, to change the hardness of their surfaces or to change their thermal or electrical conductivities. Such oxidation processes may be performed selectively (e.g. via an adhered or contact mask) or they may be performed in a blanket fashion where any differential in oxidation amount results from a differential in reactiveness between the materials and the selected oxidation environment.

In other embodiments, the rate of deposition from a thermal spray coating process may be selected to be slow enough so as to minimize any damage to the structure and materials that the target surface is made of. In some embodiments the thermally sprayed materials may include titanium, stainless steal, tantalum, gold, platinum, silver, nickel, copper, tungsten, tungsten carbide, cobalt, chromium, various alloys such as nickel titanium, and ceramics such as zirconium. Additional processes may involve exposure of layers, partially formed layers, or released structures to various gases and heat treatments to form surfaces with desired properties. Gas treatments may include hydrogen environments, nitrogen containing environments and/or carbon containing environments. By such processes, pyrolytic carbon coatings may be formed over the structures or pyrolytic carbon coatings may be formed in other ways. Formation of pyrolytic carbon surfaces are described in U.S. Pat. No. 4,194,027, entitled “Method of Coating with Homogeneous Pyrocarbon”, and issued to Charles Adams. This patent is hereby incorporated by reference as if set forth in full herein.

In various other alternatives, selective etching may be performed in combination with selective depositions and/or blanket depositions and or the layer formation processes used in forming multilayer structures may include processes that result in the interlacing of material making up successive layers. Various electrochemical fabrication techniques that use etching and/or interlacing techniques are described U.S. patent application Ser. No. 10/434,519, filed May 7, 2003 by Smalley, and entitled “Methods of and Apparatus for Electrochemically fabricating Structure Via Interlaced Layer of Via Selective Etching and Filling of Voids”. This patent application is incorporated herein by reference as if set forth in full.

Various other embodiments of the present invention exist. Some of these embodiments may be based on a combination of the teachings herein with various teachings incorporated herein by reference. Some embodiments may not use any blanket deposition process and/or they may not use a planarization process. Some embodiments may involve the selective deposition of a plurality of different materials on a single layer or on different layers. Some embodiments may use selective deposition processes on some layers that are not electrodeposition processes. Some embodiments may use nickel as a structural material while other embodiments may use different materials. Some embodiments. Some embodiments may use copper as the structural material with or without a sacrificial material. Some embodiments may remove a sacrificial material while other embodiments may not. In some embodiments the anode (used during electrodeposition) may be different from a conformable contact mask support and the support may be a porous structure or other perforated structure. Some embodiments may use multiple conformable contact masks with different patterns so as to deposit different selective patterns of material on different layers and/or on different portions of a single layer.

In view of the teachings herein, many further embodiments, alternatives in design and uses of the instant invention will be apparent to those of skill in the art. As such, it is not intended that the invention be limited to the particular illustrative embodiments, alternatives, and uses described above but instead that it be solely limited by the claims presented hereafter.

We claim:

1. A process for forming a multilayer three-dimensional structure, comprising:
(a) forming and adhering a layer of material to a previously formed layer or to a substrate;
(b) repeating the forming and adhering operation of (a) a plurality of times to build up a three-dimensional structure from a plurality of adhered layers;
wherein the formation of at least a plurality of layers, comprises:
(1) obtaining a selective pattern of deposition of a first material having voids, comprising at least one of:
(a) selectively depositing a first material onto a substrate or previously formed layer such that voids remain; or
(b) depositing a first material onto a substrate or previously formed layer and selectively etching the deposit of the first material to form voids therein; and
(2) depositing a second material into the voids via a thermal spraying process.

2. The process of claim 1 wherein the formation of the plurality of layers additionally comprises at least one planarization operation on each of at least a portion of the plurality of layers.

3. The process of claim 1 wherein the thermal spraying process comprises at least one of: (1) an arc wire spraying process, (2) a high velocity oxygen-fuel (HVOF) spraying process, (3) a plasma spraying process, (4) a plasma transferred arc (PTA) spraying process, (5) a vacuum or low pressure plasma spraying process, (6) a low velocity oxygen-fuel (LVOF) spraying process, (7) a detonation thermal spraying process, (8) a high velocity particle consolidation (HVPC) spraying process, (9) a wire spraying process, or (10) an ion plating process.

4. The process of claim 1 wherein after depositing via a thermal spraying process an infiltration process is used to fill any surface voids with a third material.

5. The process of claim 1 wherein after depositing via a thermal spraying process, at least one subsequent operation is used wherein modification of the second material occurs or wherein adhesion between the second material deposited in association with one layer and material deposited in association with another layer is enhanced.

6. A process for forming a multilayer three-dimensional structure, comprising:
(a) forming and adhering a layer of material to a previously formed layer or to a substrate;
(b) repeating the forming and adhering operation of (a) a plurality of times to build up a three-dimensional structure from a plurality of adhered layers;
wherein the formation of at least a plurality of layers, comprises:
(1) obtaining a selective pattern of deposition of a first material having voids, comprising at least one of:
(a) selectively depositing a first material onto a substrate or previously formed layer such that voids remain; or
(b) depositing a first material onto a substrate or previously formed layer and selectively etching the deposit of the first material to form voids therein; and
(2) depositing a second material into the voids;
(3) etching the deposit of the first material or second material to form second voids; and
(4) depositing a third material into the second voids via a thermal spraying process.

7. The process of claim 6 wherein the formation of the plurality of layers additionally comprises at least two planarization operations on each of at least a portion of the plurality of layers.

8. The process of claim 6 wherein the formation of the plurality of layers additionally comprises at least one planarization operation on each of at least a portion of the plurality of layers.

9. The process of claim 6 wherein the thermal spraying process comprises at least one of: (1) an arc wire spraying process, (2) a high velocity oxygen-fuel (HVOF) spraying process, (3) a plasma spraying process, (4) a plasma transferred arc (PTA) spraying process, (5) a vacuum or low pressure plasma spraying process, (6) a low velocity oxygen-fuel (LVOF) spraying process, (7) a detonation thermal spraying process, (8) a high velocity particle consolidation (HVPC) spraying process, (9) a wire spraying process, or (10) an ion plating process.

10. The process of claim 6 wherein after depositing via a thermal spraying process an infiltration process is used to fill any surface voids with a fourth material.

11. The process of claim 6 wherein after depositing via a thermal spraying process, at least one subsequent operation is used wherein modification of the third material occurs or wherein adhesion between the third material deposited in association with one layer and material deposited in association with another layer is enhanced.

12. A process for forming a multilayer three-dimensional structure, comprising:
(a) forming and adhering a layer of material to a previously formed layer or to a substrate;
(b) repeating the forming and adhering operation of (a) a plurality of times to build up a three-dimensional structure from a plurality of adhered layers;
wherein the formation of at least a plurality of layers, comprises:
(1) obtaining a selective pattern of deposition of a first material having voids, comprising at least one of:
(a) selectively depositing a first material onto a substrate or previously formed layer such that voids remain; or
(b) depositing a first material onto a substrate or previously formed layer and selectively etching the deposit of the first material to form voids therein; and
(2) depositing a second material into the voids wherein the second material prior to deposition comprises a powder.

13. The process of claim 12 wherein the formation of the plurality of layers additionally comprises at least one planarization operation on each of at least a portion of the plurality of layers.

14. The process of claim 12 wherein the material comprising the powder, further comprises at least one of (1) at least two powders of different materials, (2) at least two powders with different particle size distributions, (3) a liquid carrier for the powder, (4) a transformable binder that can be used to bind the powder particles, or (5) a liquid carrier that can be transformed by radiation, heat, pressure, or chemical means to bind the powder particles.

15. The process of claim 12 wherein after depositing the powder an infiltration process is used to fill any surface voids with a third material.

16. The process of claim 12 wherein after depositing the powder, at least one subsequent operation is used wherein modification of the second material occurs or wherein adhesion between the second material deposited in association with one layer and material deposited in association with another layer is enhanced.

17. A process for forming a multilayer three-dimensional structure, comprising:
(a) forming and adhering a layer of material to a previously formed layer or to a substrate;
(b) repeating the forming and adhering operation of (a) a plurality of times to build up a three-dimensional structure from a plurality of adhered layers;
wherein the formation of at least a plurality of layers, comprise:
(1) obtaining a selective pattern of deposition of a first material having voids, comprising at least one of:
(a) selectively depositing a first material onto a substrate or previously formed layer such that voids remain; or
(b) depositing a first material onto a substrate or previously formed layer and selectively etching the deposit of the first material to form voids therein; and
(2) depositing a second material into the voids;
(3) etching the deposit of the first material or second material to form second voids; and
(4) depositing a third material into the second voids, wherein the third material prior to deposition comprises a powder.

18. The process of claim 17 wherein the formation of the plurality of layers additionally comprises at least two planarization operations on each of at least a portion of the plurality of layers.

19. The process of claim 17 wherein the formation of the plurality of layers additionally comprises at least one planarization operation on each of at least a portion of the plurality of layers.

20. The process of claim 17 wherein the material comprising the powder, further comprises at least one of (1) at least two powders of different materials, (2) at least two powders with different particle size distributions, (3) a liquid carrier for the powder, (4) a transformable binder that can be used to bind the powder particles, or (5) a liquid carrier that can be transformed by radiation, heat, pressure, or chemical means to bind the powder particles.

21. The process of claim 17 wherein after depositing the powder an infiltration process is used to fill any surface voids with a third material.

22. The process of claim 17 wherein after depositing the powder, at least one subsequent operation is used wherein modification of the second material occurs or wherein adhesion between the second material deposited in association with one layer and material deposited in association with another
